(19) United States
(12) Patent Application Publication
(10) Pub. No.: US 2020/0150779 A1
(43) Pub. Date: May 14, 2020

(54) KEYBOARD

(71) Applicant: Nimisha Jain, San Francisco, CA (US)

(72) Inventor: Nimisha Jain, San Francisco, CA (US)

(21) Appl. No.: 16/190,940

(22) Filed: Nov. 14, 2018

(51) Int. Cl. G06F 3/02

(52) U.S. Cl. CPC G06F 3/0219

(57) ABSTRACT

A keyboard facilitates efficient, intuitive, and speedy data entry in, for example, Hindi, via its Devanagari script. The keyboard has one or more of the following features: single-hand operation; ergonomic operation; a first group of keys positioned for operation by an operator's thumb; a second group of keys positioned for operation by one or more non-thumb fingers of the operator; a separation between the first and second groups of keys; a key layout based on frequency of character usage; within each distinct group of keys, one or more keys that are sized and shaped for operation using fine motor skills of fingertips; and keying motions that parallel composition of words and sentences in any Brahmic script, such as Bengali, Buginese, Buh d Burmese, Devanagari, Gujarati, Gurmukhi, Hanunoo, Kannada, Khmer, Lao, Limbu, Malayalam, Oriya, Sinhala, Syloti Nari, Tagalog, Tagbanwa, Tai Le, Tamil, Telugu, Thai, or Tibetan.

### TECHNICAL FIELD

The subject matter disclosed herein generally relates to the technical field of apparatus (e.g., devices) that facilitate data entry (e.g., typing), including variants implemented as a mechanical device, as a graphical user interface presented by a touchscreen, or as any suitable combination thereof, and including improvements to such variants, and to the technologies by which such apparatus become improved compared to other apparatus that facilitate data entry.

### BACKGROUND

English uses Latin script, which is a linear writing system that uses the Latin alphabet, in which all characters are separate units (e.g., selected and placed sequentially). In contrast, Hindi uses Devanagari script, which is writing system in which consonant-vowel pairs are often written together as a unit. Such a writing system is known as an abugida. The Devanagari script has two types of characters: base characters (e.g., consonants) and diacritics (e.g., vowels) that modify base characters. The Latin script has 26 characters, while the Devanagari script has about 45 main characters. Both writing systems are phonetic, unlike Mandarin script which is logosyllabic and accordingly uses pictures to represent words. Since each Devanagari consonant has an inherent vowel sound, the Devanagari consonant may appear without a following vowel.

Data-entry devices (e.g., keyboards) are examples of apparatus (e.g., hardware) that can be used by a user (e.g., a human operator of a keyboard) to input information into one or more machines or other devices. However, most keyboards available today are configured for the English language and its Latin script. For users interested in inputting information in the Hindi language via its Devanagari script (e.g., in real time, such as when composing documents or other writings), current technical solutions may be unsatisfactory.

For example, transliteration (e.g., via suitably programmed software, hardware, or both) interprets combinations of two or three inputted Latin characters as a fully formed Devanagari character (e.g., represented as a corresponding Unicode code point for that Devanagari character). Transliteration typically involves active review by the user to ensure that the software has properly converted Latin characters to the intended Devanagari ones. Direct typing may be done through QWERTY-based layouts, like the Remington Hindi Layout, which includes software (e.g., a driver) that converts keystrokes or key combinations precisely to Devanagari characters. For example, “J” key inputs the “ [symbol] ” character. However, QWERTY-based typing is inefficient, unintuitive, and time-consuming (e.g., six months) to learn. As a workaround, hiring or otherwise supervising a typist skilled in QWERTY-based precise typing may be somewhat more intuitive, but nonetheless still inefficient and time-consuming (e.g., in supervision, proofreading, and other communication). As another example, voice-recognition of spoken Hindi may eventually show promise, but currently are inefficient and time-consuming (e.g., due to lack of accuracy, errors from noisy environment, errors for users with uncommon accents).

### BRIEF DESCRIPTION OF THE DRAWINGS

Some embodiments are illustrated by way of example and not limitation in the figures of the accompanying drawings.

FIG. 1 is a top view of a keyboard having a proximal group of keys and a distal group of keys, according to some example embodiments.

FIG. 2 is a top view of the keyboard, showing the proximal group of keys enclosed in a first area and showing the distal group of keys enclosed in a second area, according to some example embodiments.

FIG. 3 is a top view of the keyboard, showing the proximal and distal groups of keys each including at least one curved row of keys with curved contact surfaces, the curved rows having radii of curvature centered at the same reference point, according to some example embodiments,

FIG. 4 is a top view of the keyboard, showing the proximal and distal groups of keys each including at least one curved row of keys with curved contact surfaces, the curved rows in the proximal group having radii of curvature centered at a first reference point, the curved rows in the distal group having radii of curvature centered at a second reference point, according to some example embodiments.

FIG. 5 is a top view of the keyboard, showing Devanagari consonants assigned to corresponding keys in the distal group of keys and showing Devanagari vowels assigned to corresponding keys in the proximal group of keys, according to some example embodiments.

FIG. 6 is a top view of the keyboard, showing a proximal group of punctuation keys and a distal group of alpha-numeric keys, according to some example embodiments.

FIG. 7 is a top view of the keyboard, showing Latin consonants assigned to corresponding keys in the distal group of alphanumeric keys and showing Latin punctuation marks assigned to corresponding keys in the proximal group of punctuation keys, according to some example embodiments.

FIG. 8 is a block diagram of configurations in which the keyboard inputs information to devices, according to some example embodiments.

FIG. 9 is a block diagram of hardware components of the keyboard in operation when communicating information to a device, according to some example embodiments.

### DETAILED DESCRIPTION

Examples of a keyboard are discussed herein, and such examples merely typify possible variations of the technology discussed herein for improving keyboards. Unless explicitly stated otherwise, structures (e.g., structural components) are optional and may be combined or subdivided, and operations may vary in sequence or be combined or subdivided. In the following description, for purposes of explanation, numerous specific details are set forth to provide a thorough understanding of various example embodiments. It will be evident to one skilled in the art, however, that the present subject matter may be practiced without these specific details.

A keyboard made (e.g., built or manufactured), modified (e.g., altered or customized), or otherwise configured (e.g., adapted) in accordance with the subject matter discussed herein facilitates efficient, intuitive, and speedy input of information (e.g., data-entry) in the Hindi language, via Devanagari script, or both. According to various example embodiments, the keyboard has one or more of the following features: single-hand (e.g., left-hand only or right-hand only) operation (e.g., in conjunction with a mouse or stylus in the other hand); anti-fatigue or otherwise ergonomic operation; a first group of keys positioned for operation by a thumb digit (e.g., a thumb finger) of a human operator's hand; a second group of keys positioned for operation by one or more non-thumb digits (e.g., a non-thumb finger, such as an index finger, a middle finger, a ring finger, or a pinky finger) of the same hand; a separation gap or other tangible demarcation between the first and second groups of keys; a key arrangement (e.g., a non-QWERTY key layout or a modified QWERTY-based key layout, such as one with additional keys) based on frequency of character usage; within each distinct group of keys, one or more keys that are sized, shaped (e.g., curved in their contact surfaces), or both, for operation using fine motor skills of a fingertip of the operator; and keying motions consistent with composition of Hindi words and sentences in Devanagari script (e.g., first choosing a consonant as a base character, then adding a vowel as a diacritic or other mark, then choosing a next consonant to be a next base character, and so on).

Although, for purposes of brevity and clarity, much of the discussion herein focuses on example embodiments in which the keyboard is configured for input of information in the Hindi language via its Devanagari script, alternative example embodiments may be configured for input of information in any Brahmic script (e.g., Bengali, Buginese, Buhid, Burmese, Gujarati, Gurmukhi, Hanunoo, Kannada, Khmer, Lao, Limbu, Malayalam, Oriya, Sinhala, Syloti Nagri, Tagalog, Tagbanwa, Tai Le, Tamil, Telugu, Thai, or Tibetan). Moreover, some example embodiments are configured for input of information in Latin script (e.g., as a primary script or as a secondary script that is selectable on a multi-script keyboard, for example, by switching keyboard modes or by holding a function key). Furthermore, certain example embodiments are configured for input of information in any nonlinear writing system in which one group of characters has a different functionality than another group of characters (e.g., Romanized Mandarin script (Hanyu Pinyin), in which Latin characters may be written with tonal diacritics, or Arabic script, which has multiple types of diacritics).

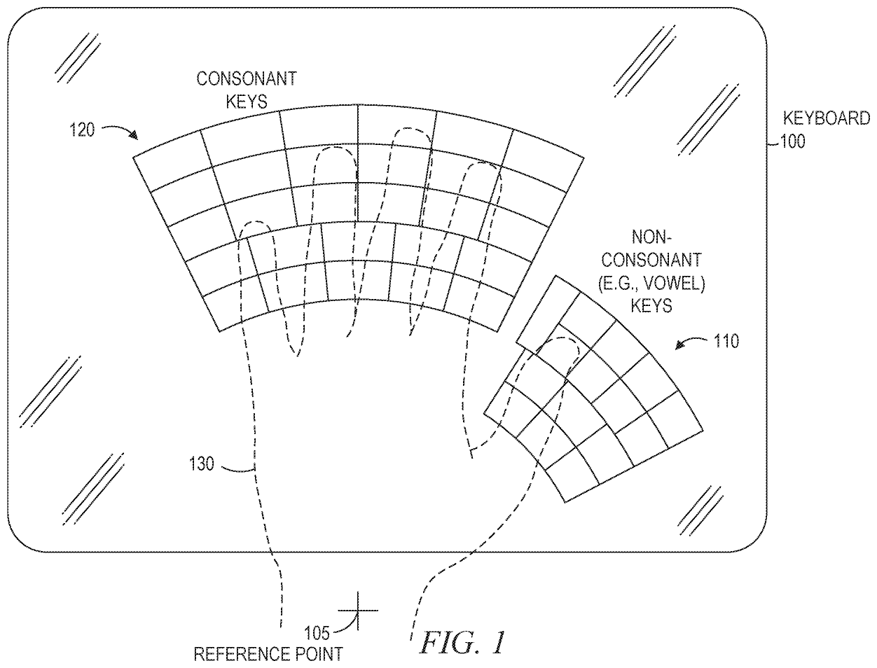

FIG. 1 is a top view of a keyboard 100 having a proximal group 110 (e.g., a proximal cluster or a proximal array) of keys and a distal group 120 (e.g., a distal cluster or a distal array) of keys, according to some example embodiments. The keyboard 100 may have an internal chassis and an external housing, and the proximal and distal groups 110 and 120 of keys may be affixed as shown to the internal chassis, located as shown relative to the external housing (e.g., mounted or otherwise disposed on the external housing, operable through one or more cutouts in the external housing, displayed on a touch screen affixed to the external housing or accessible through a cutout in the external housing, or any suitable combination thereof), or both.

As shown, the proximal group 110 may include (e.g., primarily or entirely) non-consonant keys, such as vowel keys, and the distal group 120 may include (e.g., primarily or entirely) consonant keys. Furthermore, the proximal group 110 may exclude consonant keys or otherwise contain no consonant keys, and the distal group 120 may exclude non-consonant keys (e.g., vowel keys) or otherwise contain no non-consonant keys.

According to various example embodiments, each non-consonant key in the proximal group 110 corresponds to a different non-consonant of a script (e.g., Devanagari script or other Brahmic script) and accordingly may be marked (e.g., labeled) with its corresponding non-consonant and may cause the keyboard 100 to output the corresponding non-consonant in response to operation of that non-consonant key. Similarly, each consonant key in the distal group 120 corresponds to a different consonant of the script and accordingly may be marked with its corresponding consonant and may cause the keyboard 100 to output the corresponding consonant in response to operation of that consonant key.

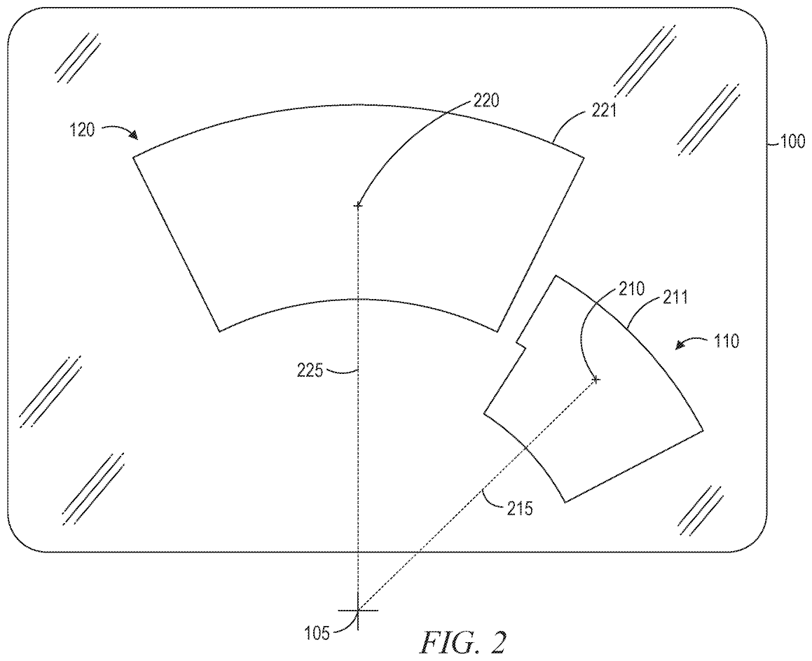

As shown in FIG. 1, the proximal group 110 of keys is configured (e.g., positioned or otherwise disposed) to be operated by a thumb digit of a hand 130 of a human operator of the keyboard 100, and the distal group 120 of keys is configured to be operated by one or more non-thumb digits of the same hand 130. In some example embodiments, to facilitate ergonomic (e.g., anti-fatigue) operation, a reference point 105 located substantially under the wrist joint of the hand 130 (e.g., substantially under the center of the radiocarpal joint) defines one or more aspects of the proximal group 110 of keys, the distal group 120 of keys, or both. Such aspects are discussed below with respect to FIGS. 2-4.

FIG. 2 is a top view of the keyboard 100, showing the proximal group 110 of keys being enclosed in a first area 211 (e.g., a first region) and showing the distal group 120 of keys being enclosed in a second area 221 (e.g., a second region), according to some example embodiments. As shown, the first area 211 has a corresponding centroid 210 (e.g., a first centroid) that is a first distance 215 from the reference point 105; the second area 221 has a corresponding centroid 220 (e.g., a second centroid) that is a second distance 225 from the same reference point 105; and the second distance 225 exceeds the first distance 215 (e.g., to facilitate ergonomic and contemporaneous operation of the proximal group 110 of keys by the thumb digit of the hand 130 in conjunction with operation of the distal group 120 of keys by one or more non-thumb digits of the hand 130).

According to certain example embodiments, the keyboard 100 includes a separation between the proximal group 110 of keys and the distal group 120 of keys. For example, the keys (e.g., non-consonant keys) in the proximal group 110 may be separated by an inter-key distance (e.g., 0.5-1.0 millimeters), and the keys (e.g., consonant keys) in the distal group 120 may also be separated by the inter-key distance, while the proximal group 110 itself may be separated from the distal group 120 by an inter-group distance (e.g., an inter-cluster distance or an inter-array distance, such as 2.0-15.0 millimeters) that is greater than the inter-key distance.

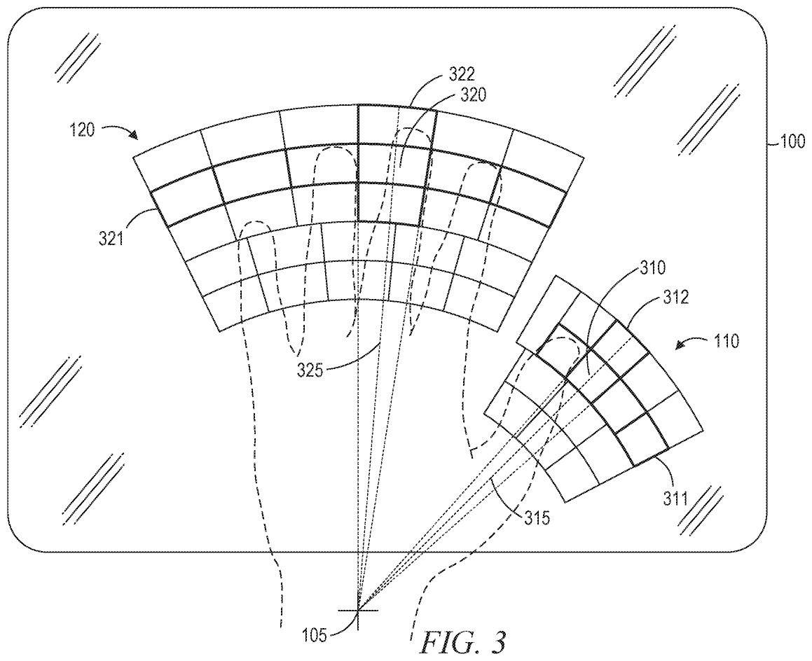

FIG. 3 is a top view of the keyboard 100, according to some example embodiments, looking down at contact surfaces (e.g., top surfaces or finger contact surfaces) of the keys in the proximal and distal groups 110 and 120 of keys. FIG. 3 shows the proximal and distal groups 110 and 120 of keys each including at least one curved row of keys (e.g., keys that each have a curved contact surface). The curved rows each has a corresponding radius of curvature, and these radii of curvature may all be centered at the same reference point 105, which may be located substantially under the wrist joint of the hand 130 of the operator.

As shown in FIG. 3, the proximal group 110 of keys includes at least one curved row 311 of keys. For example, in addition to the curved row 311 of keys, three additional curved rows of keys are visible in FIG. 3. The proximal group 110 of keys also includes at least one column 312 of keys, and each column of keys in the proximal group 110 may be aligned to a different radial line extending from the reference point 105. In certain example embodiments, the proximal group 110 of keys has at least two of such columns of keys. For example, four columns of keys are visible in one portion (e.g., a distal portion) of the proximal group 110, each aligned to a different radial line extending from the reference point 105, and three columns of keys are visible in another portion (e.g., a proximal portion) of the proximal group 110, each also aligned to a different radial extending from the reference point 105.

In the proximal group 110 of keys, a key 310 at the intersection of the curved row 311 and the column 312 is included in both the curved row 311 and the column 312, and the key 310 has a corresponding contact surface (e.g., a top surface) that is operable (e.g., configured to be pressed, touched, or otherwise actuated) by a finger (e.g., a thumb finger of the hand 130) of the human operator of the keyboard 100. According to some example embodiments, the contact surface of the key 310 may be curved, and the corresponding radius of curvature for the contact surface (e.g., at its proximal edge or its distal edge) may be centered at the same reference point 105 at which the radius of curvature for the corresponding curved row 311 is centered.

As further shown in FIG. 3, the distal group 120 of keys includes at least one curved row 321 of keys. For example, in addition to the curved row 321 of keys, four additional curved rows of keys are visible in FIG. 3. The distal group 120 of keys also includes at least one column 322 of keys, and each column of keys in the distal group 120 may be aligned to a different radial line extending from the reference point 105. In certain example embodiments, the distal group 120 of keys has at least three of such columns of keys. For example, six columns of keys are visible in one portion(e.g., a distal portion) of the distal group 120, each aligned to a different radial line extending from the reference point 105, and five columns of keys are visible in another portion (e.g., a proximal portion) of the distal group 120, each also aligned to a different radial line extending from the reference point 105.

In the distal group 120 of keys, a key 320 at the intersection of the curved row 321 and the column 322 is included in both the curved. row 321 and the column 322, and the key 320 has a corresponding contact surface (e.g., a top surface) that is operable by a finger (e.g., a non-thumb finger of the hand 130) of the human operator of the keyboard 100. According some example embodiments, the contact surface of the key 320 may be curved, and the corresponding radius of curvature for the contact surface (e.g., at its proximal edge or its distal edge) may be centered at the same reference point 105 at which the radius of curvature for the corresponding curved row 321 is centered.

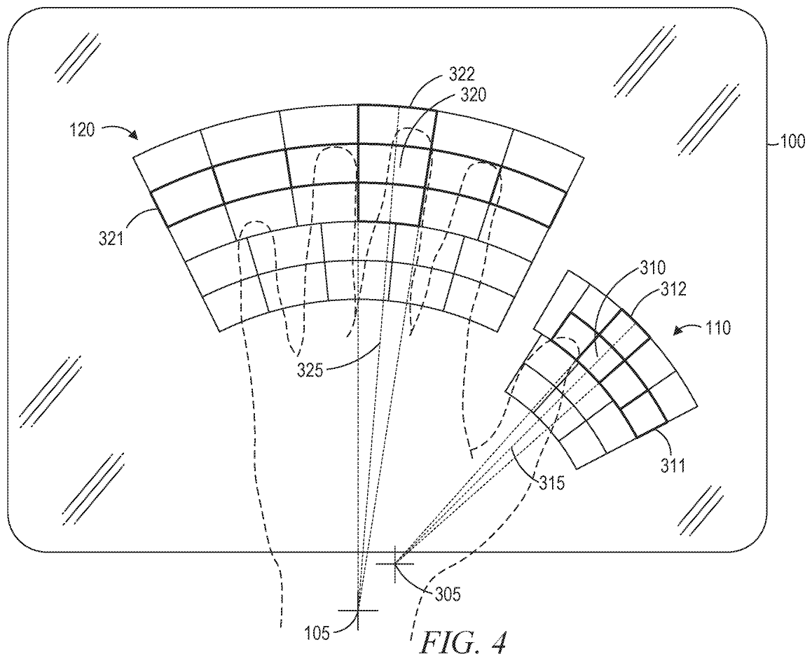

FIG. 4 is a top view of the keyboard 100, according to some example embodiments, again looking down at the contact surfaces (e.g., top surfaces or finger contact surfaces) of the keys in the proximal and distal groups 110 and 120 of keys. FIG. 4 shows the proximal and distal groups 110 and 120 of keys each including at least one curved row of keys (e.g., keys that each have a curved contact surface). The curved rows (e.g., curved row 311) in the proximal group 110 each have a corresponding radius of curvature that is centered at the reference point 105 (e.g., a first reference point), while the curved rows (e.g., curved row 312) in the distal group 120 each have a corresponding radius of curvature that is centered at another reference point 305 (e.g., a second reference point) that is distinct and separate from the reference point 105 at which the radii of curvature for the curved rows in the proximal group 110 are centered. As noted above, the reference point 105 (e.g., the first reference point) may be located substantially under the wrist joint of the hand 130 of the operator. In contrast, the reference point 305 (e.g., the second reference point) may be located substantially under the base of the thumb of the hand 130 (e.g., substantially under the center of the thumb basal joint or carpometacarpal (CMC) joint) of the operator.

As shown in FIG. 4, the proximal group 110 of keys includes at least one curved row 311 of keys. For example, in addition to the curved row 311 of keys, three additional curved rows of keys are visible in FIG. 4. The proximal group 110 of keys also includes at least one column 312 of keys, and each column (e.g., column 312) of keys in the proximal group 110 may be aligned to a different radial line extending from the reference point 305 (e.g., the second reference point). In certain example embodiments, the proximal group 110 of keys has at least two of such columns of keys. For example, four columns of keys are visible in one portion (e.g., the distal portion) of the proximal group 110, each aligned to a different radial line extending from the reference point 305 (e.g., the second reference point), and three columns of keys are visible in another portion (e.g., the proximal portion) of the proximal group 110, each also aligned to a different radial line extending from the reference point 305.

In the proximal group 110 of keys, a key 310 at the intersection of the curved row 311 and the column 312 is included in both the curved row 311 and the column 312, and the key 310 has a corresponding contact surface (e.g., a top surface) that is operable (e.g., configured to be pressed, touched are otherwise actuated) by a finger (e.g., a thumb finger of the hand 130) of the human operator of the keyboard 100. According to some example embodiments, the contact surface of the key 310 may be curved, and the corresponding radius of curvature for the contact surface (e.g., at its proximal edge or its distal edge) may be centered at the same reference point 305 (e.g., the second reference point) at which the radius of curvature for the corresponding curved row 311 is centered.

As further shown in FIG. 4, the distal group 120 of keys includes at least one curved row 321 of keys. For example, in addition to the curved row 321 of keys, four additional curved rows of keys are visible in FIG. 4. The distal group 120 of keys also includes at least one column 322 of keys, and each column (e.g., column 322) of keys in the distal group 120 may be aligned to a different radial line extending from the reference point 105 (e.g., the first reference point). In certain example embodiments, the distal group 120 of keys has at least three of such columns of keys. For example, six columns of keys are visible in one portion (e.g., the distal portion) of the distal group 120, each aligned to a different radial line extending from the reference point 105 (e.g., the first reference point), and five columns of keys are visible in another portion (e.g., the proximal portion) of the distal group 120, each also aligned to a different radial line extending from the reference point 105.

In the distal group 120 of keys, a key 320 at the intersection of the curved row 321 and the column 322 is included in both the curved row 321 and the column 322, and the key 320 has a corresponding contact surface (e.g., a top surface) that is operable by a finger (e.g., a non-thumb finger of the hand 130) of the human operator of the keyboard 100. According some example embodiments, the contact surface of the key 320 may be curved, and the corresponding radius of curvature for the contact surface (e.g., at its proximal edge or its distal edge) may be centered at the same reference point 105 (e.g., the first reference point) at which the radius of curvature for the corresponding curved row 321 is centered.

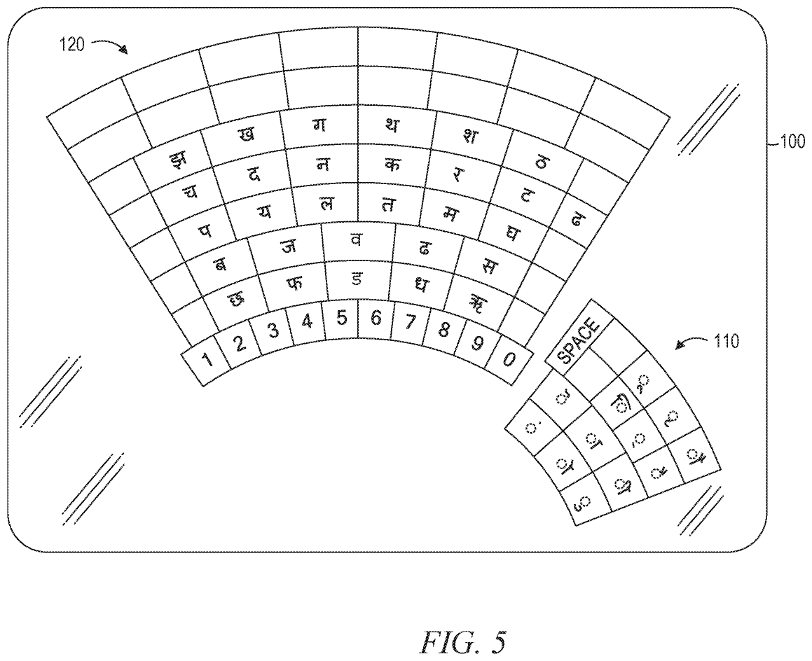

FIG. 5 is a top view of the keyboard 100, showing Devanagari consonants assigned to respectively corresponding keys in the distal group 120 of keys and showing Devanagari vowels assigned to respectively corresponding keys in the proximal group 110 of keys, according to some example embodiments. According to various example embodiments, the proximal group 110 of keys includes one or more (e.g., at least one) non-consonant key (e.g., key 310). Examples of such a non-consonant key include a vowel key (e.g., as shown in FIG. 5), a semi-vowel key, a diacritic key, a punctuation key, or any suitable combination thereof Furthermore, to illustrate certain example embodiments, FIG. 5 depicts a curved row of numeric keys within the distal group 120 of keys.

In contrast with linear selection of sequential Latin characters to compose words and sentences when writing in English, the composition of words and sentences when writing in Hindi is typically stepwise and includes alternating between selection of consonants and vowels (e.g., selecting a consonant, then selecting a vowel to add its corresponding diacritic to the previously selected consonant, then selecting the next consonant, and so on). Accordingly, operation of the keyboard 100, as pictured in FIG. 5, may be performed by the hand 130 alternating keystrokes between consonant keys in the distal group 120 of keys and vowel keys in the proximal group 110 of keys. Hence, operation the keyboard 100 may be performed by the thumb finger of the hand 130 alternating with non-thumb fingers of the hand 130 in performing keystrokes that respectively alternate between the proximal group 110 of keys and the distal group 120 of keys.

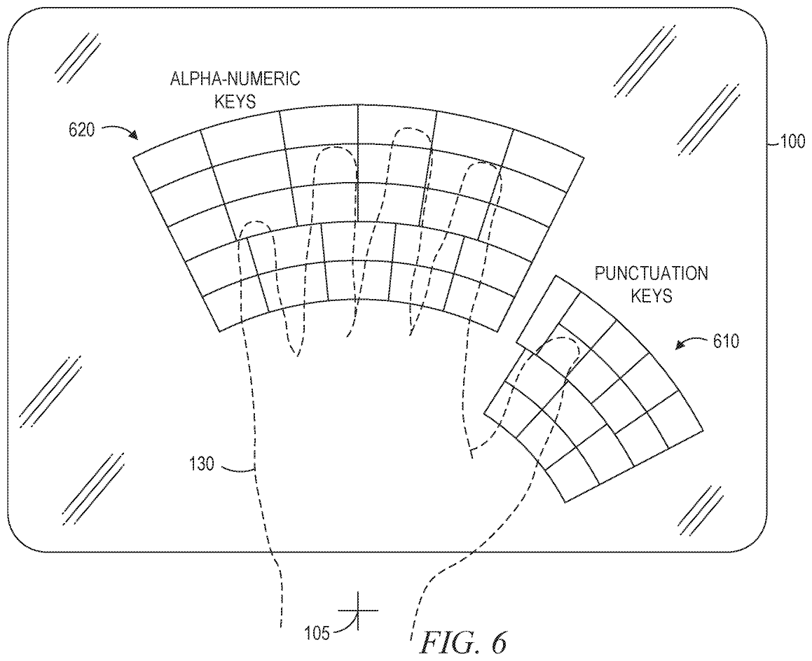

FIG. 6 is a top view of the keyboard 100, showing a proximal group 610 of punctuation keys and a distal group 620 of alpha-numeric keys, according to some example embodiments. Such a layout of keys may be suitable for inputting information in English, Hindi, or any other suitable language, and such a layout may be available for selection (e.g., as a primary script or as a secondary script) by the human operator of the keyboard 100. For example, the keyboard 100 may be a multi-script keyboard that can be configured to use the key layout shown in FIG. 6, for example, by switching keyboard modes or by holding a function key.

As shown, the proximal group 610 may include (e.g., primarily or entirely) punctuation keys, and the distal group 620 may include (e.g., primarily or entirely) alpha-numeric keys. Furthermore, the proximal group 610 may exclude non-punctuation keys or otherwise contain no alpha-numeric keys, and the distal group 620 may exclude non-alpha-numeric keys or otherwise contain no non-alpha-numeric keys. In some example embodiments, the proximal group 610 includes one or more non-alpha-numeric keys (e.g., including symbols, such as “@,” “#,” and “$”), in addition to punctuation keys.

According to various example embodiments, each punctuation key in the proximal group 610 corresponds to a different punctuation mark of a script (e.g., Latin script, Devanagari script, or other script) and accordingly may be marked (e.g., labeled) with its corresponding punctuation mark and may cause the keyboard 100 to output the corresponding punctuation mark in response to operation of that punctuation key. Similarly, each alpha-numeric key in the distal group 620 corresponds to a different alpha-numeric character of the script and accordingly may be marked with its corresponding alpha-numeric character (e.g., a letter or a numeral) and may cause the keyboard 100 to output the corresponding alpha-numeric character in response to operation of that alpha-numeric key.

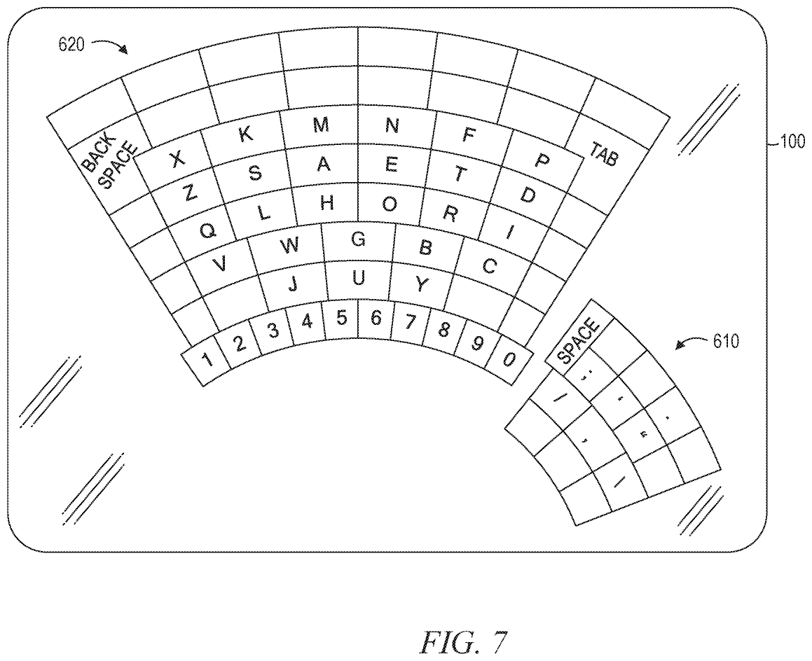

FIG. 7 is a top view of the keyboard 100, showing Latin consonants assigned to corresponding keys in the distal group 620 of alpha-numeric keys and showing Latin punctuation marks assigned to corresponding keys in the proximal group 610 of punctuation keys, according to some example embodiments. Such a layout of keys may be suitable for inputting information in English or any other language that uses the Latin script. As noted above, such a layout may be available for selection by the human operator of the keyboard 100 (e.g., via switching keyboard modes or via holding a function key).

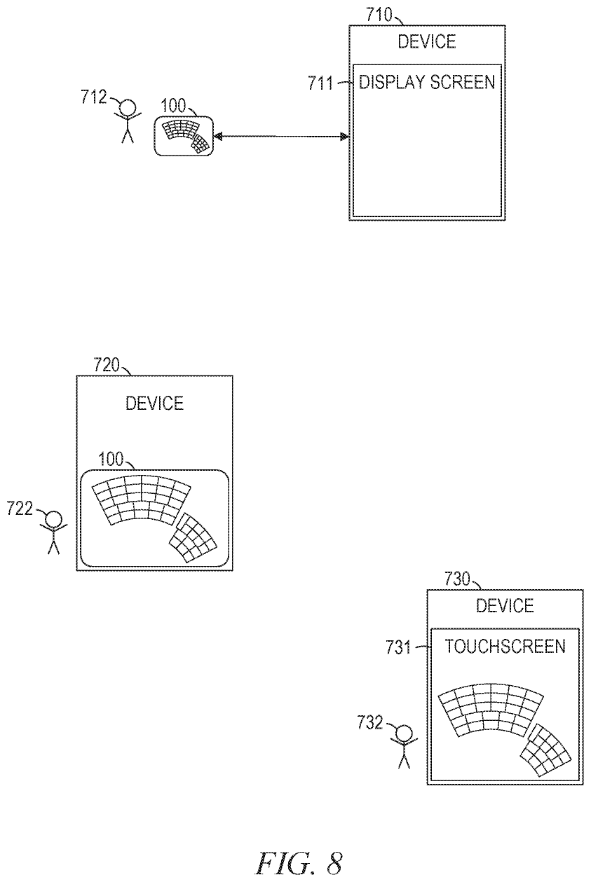

FIG. 8 is a block diagram of configurations in which the keyboard 100 inputs information into (e.g., outputs information to) devices 710, 720, and 730, according to some example embodiments. As shown in the top portion of FIG. 8, a human operator 712 performs data-entry by using his or her hand (e.g., hand 130) to type on an instance of the keyboard 100, and the instance of the keyboard 100 generates and outputs corresponding text data (e.g., ASCII code points, Unicode code points, or any suitable combination thereof), The keyboard-generated text data is sent via a wired or wireless communication link to the device 710, which may display the outputted text data on a display screen 711.

As shown in the middle portion of FIG. 8, an instance of the keyboard 100 is included (e.g., embedded) in the device 720, and a human operator 722 performs data-entry by using his or her hand (e.g., hand 130) to type on the instance of the keyboard 100. The instance of the keyboard 100 generates corresponding text data (e.g., ASCII code points, Unicode code points, or any suitable combination thereof) and provides the generated text data elsewhere internally within the device 720. In some example embodiments, the device 720 also includes a display screen (e.g., similar to the display screen 711) and accordingly displays the outputted text data thereon.

As shown in the bottom portion of FIG. 8, an instance of the keyboard 100 may be presented (e.g., displayed, with or without haptic features) as all or part of a graphical user interface (e.g., in the form of a virtual keyboard) on a touchscreen 731 of the device 730. A human operator 732 performs data-entry by using his or her hand (e.g., hand 130) to type on the instance of the keyboard 100 presented on the touchscreen 731. The graphically presented instance of the keyboard 100 (e.g., as configured by software executing on one or more processors of the device 730) generates corresponding text data (e.g., ASCII code points, Unicode code points, or any suitable combination thereof) and provides the generated text data elsewhere internally within the device 720. In certain example embodiments, the device 730 accordingly displays the outputted text data on the touchscreen 731.

The human operator 712 is associated with the device 710 and may be a user of the device 710. For example, the device 710 may be a desktop computer, a vehicle computer, a home media system (e.g., a home theater system or other home entertainment system), a tablet computer, a navigational device, a portable media. device, a smart phone, or a wearable device (e.g., a smart watch, smart glasses, smart clothing, or smart jewelry) belonging to the user 712. Likewise, the human operator 722. is associated with the device 720 and may be a user of the device 720. As an example, the device 720 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 722. Similarly, the human operator 732 is associated with the device 730 and may be a user of the device 730. As an example, the device 730 may be a desktop computer, a vehicle computer, a home media system (e.g., a home theater system or other home entertainment system), a tablet computer, a navigational device, a portable media device, a smart phone, or a wearable device (e.g., a smart watch, smart glasses, smart clothing, or smart jewelry) belonging to the user 732.

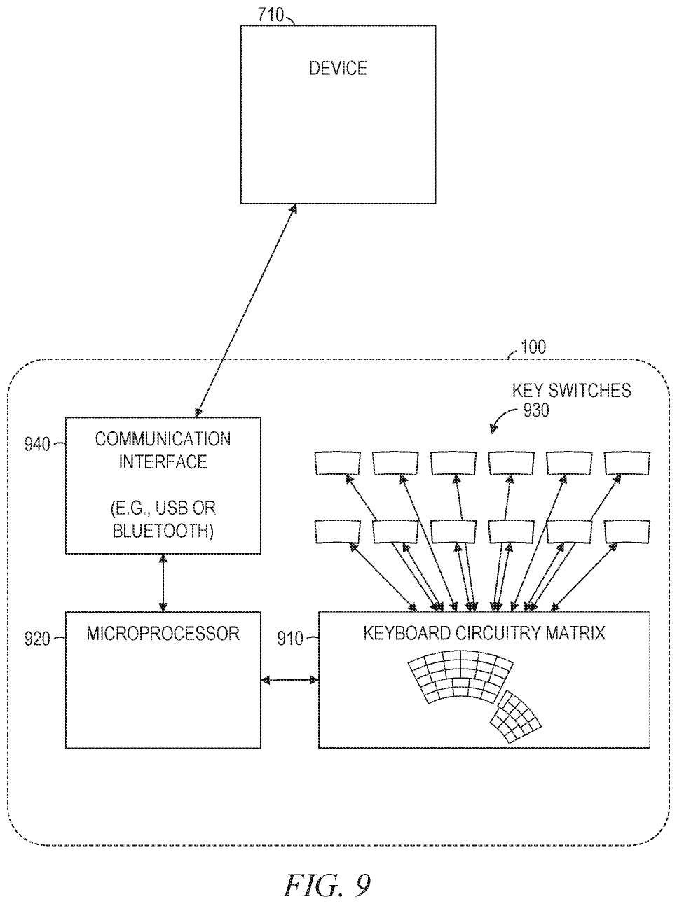

FIG. 9 is a block diagram of hardware components of the keyboard 100 in operation to communicate information (e.g., in performing data-entry) to the device 710, according to some example embodiments. As shown in FIG. 9, the keyboard 100 is configured to input information into (e.g., output or otherwise send information to) the device 710.

Within the keyboard 100, a keyboard circuitry matrix 910 has corresponding open gates at corresponding locations for keys (e.g., key 310 or 320) of the keyboard 100. Each key (e.g., key 310) has a corresponding gate in the keyboard circuitry matrix 910. Each open gate is normally (e.g., spring loaded) open and can be closed with a key press or other actuation movement on the corresponding key (e.g., performed by a digit of the hand 130). In various example embodiments, the keyboard circuitry matrix 910 is or includes a printed circuit board or is otherwise fully or partially hardwired. Such a printed circuit board may form all or part of a chassis, motherboard, or other structural substrate upon which key switches 930 are mounted, affixed, or otherwise disposed.

A microprocessor 920 is configured (e.g., by suitable firmware or other software) to convert signals (e.g., electrical or optical) from the keyboard circuitry matrix 910 into codes (e.g., Unicode codes) that the operating system of the device 710 can decode or otherwise recognize as text information. The microprocessor 920 communicates with the device 710 via a communication interface 940, which may be a wired communication interface (e.g., universal serial bus (USB)) or a wireless communication interface (e.g., Bluetooth).

Each one of the key switches 930 corresponds to a different key of the keyboard 100 and may be topped with a corresponding key cap or other contact surface that is labelled (e.g., printed or painted) with a corresponding symbol (e.g., as described above with respect to FIG. 5, FIG. 7, or both). As noted above with respect to FIG. 3 and FIG. 4, the contact surface (e.g., key cap) of any key (e.g., key 310) may be curved, and the corresponding radius of curvature for that contact surface (e.g., at its proximal edge or its distal edge) may be centered at a reference point (e.g., reference point 105 or 305).

Each key switch, when pressed, closes a corresponding open gate in the keyboard circuitry matrix 910, allowing current to flow through the closed corresponding gate. The keyboard circuitry matrix 910 includes an arrangement (e.g., curved rows and radial columns) of such gates, and the pressed key switch may be identifiable by the position of its corresponding gate the within the arrangement. Accordingly, the microprocessor 920 determines (e.g., based on the corresponding row and corresponding column of the pressed key) which code (e.g., Unicode code) to send through the communication interface 940 to the device 710.

According to various example embodiments, each key switch among the key switches 930 may be a mechanical switch (e.g., in which the corresponding gate is closed inside a mechanism) or a membrane switch (e.g., in which the rows are in one membrane, while the columns are in another membrane layered over the membrane of rows, and a row-column pair becomes determined when a row and a column become connected via a key press that squeezes the two stacked membranes together at the location of the corresponding key). The components of the keyboard 100, according to various example embodiments, may be contained in a case or other housing (e.g., to conceal or protect the hardware components and associated inter-component wiring).

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and their functionality presented as separate components and functions in example configurations may be implemented as a combined structure or component with combined functions. Similarly, structures and functionality presented as a single component may be implemented as separate components and functions. These and other variations, modifications, additions, and improvements fall within the scope of the subject matter herein. Unless specifically stated otherwise, the terms “a” or “an” are herein used, as is common in patent documents, to include one or more than one instance. As used herein, the conjunction “or” refers to a non-exclusive “or,” unless specifically stated otherwise.

The following enumerated descriptions describe various examples of apparatus (e.g., mechanical keyboards, touchscreen keyboards, or other data-entry devices) discussed herein.

A first example provides an apparatus (e.g., a data-entry device, such as an instance of the keyboard 100) comprising:
a housing;
a proximal array of keys (e.g., a non-consonant array of keys) disposed on the housing, the proximal array of keys including non-consonant keys and including no consonant keys, the proximal array being disposed within a first area whose centroid is a first distance from a reference point (e.g., as shown in FIGS. 1 and 2), each non-consonant key among the non-consonant keys corresponding to a different non-consonant of a script; and
a distal array of keys (e.g., a consonant array of keys) disposed on the housing, the distal array of keys including consonant keys and including no non-consonant keys,
the distal array being disposed within a second area whose centroid is a second distance that exceeds the first distance from the reference point (e.g., as shown in FIGS. 1 and 2), each consonant key among the consonant keys corresponding to a different consonant of the script.

A second example provides an apparatus according to the first example, wherein:
the proximal array of keys is configured to be operated by a thumb finger of a hand of a human operator (e.g., as shown in FIGS. 1, 3, 4, and 6); and
the distal array of keys is configured to be operated by one or more non-thumb fingers of the hand of the human operator (e.g., as shown in FIGS. 1, 3, 4, and 6).

A third example provides an apparatus according to the first example or the second example, wherein:
the proximal and distal arrays of keys each include at least one curved row of keys, each curved row having a corresponding radius of curvature centered at the reference point. Thus, curved rows of keys in both arrays may have curvatures centered at the same reference point (e.g., as shown in FIG. 3).

A fourth example provides an apparatus according to the third example, wherein:
in each curved row of keys, each key has a corresponding contact surface operable by a finger of a human operator, the contact surface having a corresponding radius of curvature centered at the reference point at which the radius of curvature of the corresponding curved row is centered. Thus, the contact surfaces of the keys in the curved rows of both proximal and distal arrays may have their curvatures centered at the same common reference point (e.g., as shown in FIG. 3).

A fifth example provides an apparatus according to the third example or the fourth example, wherein:
the distal array of keys includes at least three distal columns of keys, each distal column being aligned to a different radial line extending from the reference point (e.g., as shown in FIG. 3); and
the proximal array of keys includes at least one proximal column of keys, each proximal column being aligned to a different radial line extending from the reference point (e.g., as shown in FIG. 3). Thus, columns of keys in both arrays may be aligned to radial lines extending from the same reference point (e.g., as shown in FIG. 3).

A sixth example provides an apparatus according to the first example or the second example, wherein:
the distal array of keys includes at least one curved row of consonant keys, each curved row of consonant keys having a corresponding radius of curvature centered at a first reference point (e.g., as shown in FIG. 4); and
the proximal array of keys includes at least one curved row of non-consonant keys, each curved row of non-consonant keys having a corresponding radius of curvature centered at a second reference point distinct from the first reference point (e.g., as shown in FIG. 4). Thus, curved rows of keys in different arrays may have curvatures centered at different reference points (e.g., as shown in FIG. 4).

A seventh example provides an apparatus according to the sixth example, wherein:
in each curved row of consonant keys in the distal array, each consonant key has a contact surface that has a corresponding radius of curvature centered at the first reference point at which the radius of curvature of the corresponding curved row is centered (e.g., as shown in FIG. 4); and
in each curved row of non-consonant keys in the proximal array, each non-consonant key has a contact surface that has a corresponding radius of curvature centered at the second reference point at which the radius of curvature of the corresponding curved row is centered (e.g., as shown in FIG. 4). Thus, the contact surfaces of the keys in the curved rows of different arrays may have their curvatures centered at different reference points (e.g., as shown in FIG. 4).

An eighth example provides an apparatus according to the sixth example of the seventh example, wherein:
the distal array of keys includes at least three distal columns of consonant keys, each distal column being aligned to a different radial line extending from the first reference point (e.g., as shown in FIG. 4); and
the proximal array of keys includes at least one proximal column of non-consonant keys, each proximal column being aligned to a different radial line extending from the second reference point distinct from the first reference point (e.g., as shown in FIG. 4). Thus, columns of keys in different arrays may be aligned to radial lines extending from different reference points (e.g., shown in FIG. 4).

A ninth example provides an apparatus according to any of the first through eighth examples, wherein:
the proximal array of keys includes at least one non-consonant key selected from a group consisting of a vowel key, a semi-vowel key, a diacritic key, and a punctuation key.

A tenth example provides an apparatus according to any of the first through ninth examples, wherein:
the non-consonant keys in the proximal array are separated by an inter-key distance, and the consonant keys in the distal array are separated by the inter-key distance, while the proximal array is separated from the distal array by an inter-array distance that is greater than the inter-key distance.

An eleventh example provides a device (e.g., a data-entry device, such as an instance of the keyboard 100) comprising:
a chassis;
a proximal group of keys affixed to the chassis, the proximal group of keys including punctuation keys and no alpha-numeric keys, the proximal group being located within a first area whose centroid is a first distance from a reference point, each punctuation key among the punctuation keys corresponding to a different punctuation character of a script; and
a distal group of keys affixed to the chassis, the distal group of keys including alpha-numeric keys and no punctuation keys, the distal group being located within a second area whose centroid is a second distance that exceeds the first distance from the reference point, each alpha-numeric key among the alpha-numeric keys corresponding to a different alpha-numeric character of the script.

A twelfth example provides a device according to the eleventh example, wherein:
the proximal and distal groups of keys each include at least one curved row of keys, each curved row having a corresponding radius of curvature centered at the reference point.

A thirteenth example provides a device according to the twelfth example, wherein:
in each curved row of keys, each key has a corresponding contact surface operable by a finger of a hand, the contact surface having a corresponding radius of curvature centered at the reference point at which the radius of curvature of the corresponding curved row is centered.

A fourteenth example provides a device according to the twelfth example or the thirteenth example, wherein:
the distal group of keys includes at least three distal columns of keys, each distal column being aligned to a different radial line extending from the reference point; and
the proximal group of keys includes at least one proximal column of keys, each proximal column being aligned to a different radial line extending from the reference point.

A fifteenth example provides a device according to the eleventh example, wherein:
the distal group of keys includes at least one curved row of alpha-numeric keys, each curved row of alpha-numeric keys having a corresponding radius of curvature centered at a first reference point; and
the proximal group of keys includes at least one curved row of punctuation keys, each curved row of punctuation keys having a corresponding radius of curvature centered at a second reference point distinct from the first reference point.

A sixteenth example provides a device according to the fifteenth example, wherein:
in each curved row of alpha-numeric keys in the distal group, each alpha-numeric key has a contact surface that has a corresponding radius of curvature centered at the first reference point at which the radius of curvature of the corresponding curved row is centered; and
in each curved row of punctuation keys in the proximal group, each punctuation key has a contact surface that has a corresponding radius of curvature centered at the second reference point at which the radius of curvature of the corresponding curved row is centered.

A seventeenth example provides a device according to the fifteenth example or the sixteenth example, wherein:
the distal group of keys includes at least three distal columns of alpha-numeric keys, each distal column being aligned to a different radial line extending from the first reference point; and
the proximal group of keys includes at least one proximal column of punctuation keys, each proximal column being aligned to a different radial line extending from the second reference point distinct from the first reference point.

An eighteenth example provides a keyboard (e.g., the keyboard 100) comprising:
a proximal cluster of keys configured to be operated by a thumb of a hand, the proximal cluster of keys including vowel keys and no consonant keys, the proximal cluster spanning a first region whose centroid is a first distance from a reference point, each vowel key among the vowel keys being configured to cause the keyboard to output a different vowel of a script; and
a distal cluster of keys configured to be operated by one or more non-thumb digits of the hand, the distal cluster of keys including consonant keys and no vowel keys, the distal cluster spanning a second region whose centroid is a second distance that exceeds the first distance from the reference point, each consonant key among the consonant keys being configured to cause the keyboard to output a different consonant of the script.

A nineteenth example provides a keyboard according to the eighteenth example, wherein:
the distal cluster of keys includes at least one curved row of consonant keys, each curved row of consonant keys having a corresponding radius of curvature centered at a first reference point; and
the proximal cluster of keys includes at least one curved row of vowel keys, each curved row of vowel keys having a corresponding radius of curvature centered at a second reference point distinct from the first reference point.

A twentieth example provides a keyboard according to the eighteenth example or the nineteenth example, wherein:
the vowel keys in the proximal cluster are separated by an inter-key distance, and the consonant keys in the distal cluster are separated by the inter-key distance, while the proximal cluster is separated from the distal cluster by an inter-cluster distance that is greater than the inter-key distance.

What is claimed is:

1. An apparatus comprising:
a housing;
a proximal array of keys disposed on the housing, the proximal array of keys including non-consonant keys and including no consonant keys, the proximal array being disposed within a first area whose centroid is a first distance from a reference point, each non-consonant key among the non-consonant keys corresponding to a different non-consonant of a script; and
a distal array of keys disposed on the housing, the distal array of keys including consonant keys and including no non-consonant keys, the distal array being disposed within a second area whose centroid is a second distance that exceeds the first distance from the reference point, each consonant key among the consonant keys corresponding to a different consonant of the script.

2. The apparatus of claim 1, wherein:
the proximal array of keys is configured to be operated by a thumb finger a hand of a human operator; and
the distal array of keys is configured to be operated by one or more non-thumb fingers of the hand of the human operator.

3. The apparatus of claim 1, wherein:
the proximal and distal arrays of keys each include at least one curved row of keys, each curved row having a corresponding radius of curvature centered at the reference point.

4. The apparatus of claim 3, wherein:
in each curved row of keys, each key has a corresponding contact surface operable by a finger of a human operator, the contact surface having a corresponding radius of curvature centered at the reference point at which the radius of curvature of the corresponding curved row is centered.

5. The apparatus of claim 3, wherein:
the distal array of keys includes at least three distal columns of keys, each distal column being aligned to a different radial line extending from the reference point; and
the proximal array of keys includes at least one proximal column of keys, each proximal column being aligned to a different radial line extending from the reference point.

6. The apparatus of claim 1, wherein:
the distal array of keys includes at least one curved row of consonant keys, each curved row of consonant keys having a corresponding radius of curvature centered at a first reference point; and
the proximal array of keys includes at least one curved row of non-consonant keys, each curved row of non-consonant keys having a corresponding radius of curvature centered at a second reference point distinct from the first reference point.

7. The apparatus of claim 6, wherein:
in each curved row of consonant keys in the distal array, each consonant key has a contact surface that has a corresponding radius of curvature centered at the first reference point at which the radius of curvature of the corresponding curved row is centered; and
in each curved row of non-consonant keys in the proximal array, each non-consonant key has a contact surface that has a corresponding radius of curvature centered at the second reference point at which the radius of curvature of the corresponding curved row is centered.

8. The apparatus of claim 6, wherein:
the distal array of keys includes at least three distal columns of consonant keys, each distal column being aligned to a different radial line extending from the first reference point; and
the proximal array of keys includes at least one proximal column of non-consonant keys, each proximal column being aligned to a different radial line extending from the second reference point distinct from the first reference point.

9. The apparatus of claim 1, wherein:
the proximal array of keys includes at least one non-consonant key selected from a group consisting of a vowel key, a semi-vowel key, a diacritic key, and a punctuation key.

10. The apparatus of claim 1, wherein:
the non-consonant keys in the proximal array are separated by an inter-key distance, and the consonant keys in the distal array are separated by the inter-key distance, while the proximal array is separated from the distal array by an inter-array distance that is greater than the inter-key distance.

11. A data-entry device comprising:
a chassis;
a proximal group of keys affixed to the chassis, the proximal group of keys including punctuation keys and no alpha-numeric keys, the proximal group being located within a first area whose centroid is a first distance from a reference point, each punctuation key among the punctuation keys corresponding to a different punctuation character of a script; and
a distal group of keys affixed to the chassis, the distal group of keys including alpha-numeric keys and no punctuation keys, the distal group being located within a second area whose centroid is a second distance that exceeds the first distance from the reference point, each alpha-numeric key among the alpha-numeric keys corresponding to a different alpha-numeric character of the script.

12. The data-entry device of claim 11, wherein:
the proximal and distal groups of keys each include at least one curved row of keys, each curved row having a corresponding radius of curvature centered at the reference point.

13. The data-entry device of claim 12, wherein:
in each curved row of keys, each key has a corresponding contact surface operable by a finger of a hand, the contact surface having a corresponding radius of curvature centered at the reference point at which the radius of curvature of the corresponding curved row is centered.

14. The data-entry device of claim 12, wherein:
the distal group of keys includes at least three distal columns of keys, each distal column being aligned to a different radial line extending from the reference point; and
the proximal group of keys includes at least one proximal column of keys, each proximal column being aligned to a different radial line extending from the reference point.

15. The data-entry device of claim 11, wherein:
the distal group of keys includes at least one curved row of alpha-numeric keys, each curved row of alpha-numeric keys having a corresponding radius of curvature centered at a first reference point; and
the proximal group of keys includes at least one curved row of punctuation keys, each curved row of punctuation keys having a corresponding radius of curvature centered at a second reference point distinct from the first reference point.

16. The data-entry device of claim 15, wherein:
in each curved row of alpha-numeric keys in the distal group, each alpha-numeric key has a contact surface that has a corresponding radius of curvature centered at the first reference point at which the radius of curvature of the corresponding curved row is centered; and
in each curved row of punctuation keys in the proximal group, each punctuation key has a contact surface that has a corresponding radius of curvature centered at the second reference point at which the radius of curvature of the corresponding curved row is centered.

17. The data-entry device of claim 15, wherein:
the distal group of keys includes at least three distal columns of alpha-numeric keys, each distal column being aligned to a different radial line extending from the first reference point; and
the proximal group of keys includes at least one proximal column of punctuation keys, each proximal column being aligned to a different radial line extending from the second reference point distinct from the first reference point.

18. A keyboard configured to be operated by a hand, the keyboard comprising:
a proximal cluster of keys configured to be operated by a thumb of a hand, the proximal cluster of keys including vowel keys and no consonant keys, the proximal cluster spanning a first region whose centroid is a first distance from a reference point, each vowel key among the vowel keys being configured to cause the keyboard to output a different vowel of a script; and
a distal cluster of keys configured to be operated by one or more non-thumb digits of the hand, the distal cluster of keys including consonant keys and no vowel keys, the distal cluster spanning a second region whose centroid is a second distance that exceeds the first distance from the reference point, each consonant key among the consonant keys being configured to cause the keyboard to output a different consonant of the script.

19. The keyboard of claim 18, wherein:
the distal cluster of keys includes at least one curved row of consonant keys, each curved row of consonant keys having a corresponding radius of curvature centered at a first reference point; and
the proximal cluster of keys includes at least one curved row of vowel keys, each curved row of vowel keys having a corresponding radius of curvature centered at a second reference point distinct from the first reference point.

20. The keyboard of claim 18, wherein:
the vowel keys in the proximal cluster are separated by an inter-key distance, and the consonant keys in the distal cluster are separated by the inter-key distance, while the proximal cluster is separated from the distal cluster by an inter-cluster distance that is greater than the inter-key distance.
